(19) United States
(12) Patent Application Publication
(10) Pub. No.: US 2012/0163233 A1
(43) Pub. Date: Jun. 28, 2012

(54) METHOD FOR TRANSMITTING ROUTING INFORMATION AND ROUTING APPARATUS IN WIRELESS NETWORK

(75) Inventors: Anseok LEE, Daejeon (KR); Wooram Shin, Daejeon (KR); Kwang Jae Lim, Daejeon (KR); Dong Seoung Kwon, Daejeon (KR); Hyun-Jae Kim, Daejeon (KR)

(73) Assignee: ELECTRONICS AND TELECOMMUNICATIONS RESEARCH INSTITUTE, Daejeon (KR)

(21) Appl. No.: 13/295,343

(22) Filed: Nov. 14, 2011

(30) Foreign Application Priority Data
Dec. 23, 2010 (KR) 10-2010-0133699

(51) Int. Cl. H04L 12/28

(52) U.S. Cl. 370/254

(57) ABSTRACT

The present invention relates to a method for transmitting routing information in a wireless network. More particularly, the present invention relates to a method for forwarding node link information even in an environment having a limited bandwidth for transmitting routing information. A routing apparatus according to exemplary embodiment of the present invention stores network topology information in an link information unit, generates a routing update message according to a priority of each link information, and transmitting the routing update message to a network. The priority of each link information is decided based on change in network topology, and a reception time and a transmission time of link information. Accordingly, important link information can be propagated at fast speed.

### CROSS-REFERENCE TO RELATED APPLICATION

This application claims priority to and the benefit of Korean Patent Application No. 10-2010-0133699 filed in the Korean Intellectual Property Office on Dec. 23, 2010, the entire contents of which are incorporated herein by reference.

### BACKGROUND OF THE INVENTION

(a) Field of the Invention

The present invention relates to a wireless network. More particularly, the present invention relates to a method for transmitting routing information in a bandwidth limited wireless environment and a routing apparatus for supporting the method.

(b) Description of the Related Art

Many studies have been made on wireless networks for developing various communication methods. Lately, a wireless mesh network and a wireless sensor network have been receiving attention. The wireless mesh network provides a wide and fast wireless access area with low costs. The wireless sensor network includes various types of objects each having a wireless access function and controls, and information is collected and controlled through the objects.

A routing method for deciding a transmission path is needed for communication between two separate nodes in a wireless network.

For example, link state routing (LSR) is a routing method for a wireless network. According to the LSR, each node transmits link state information for neighbor nodes to all other nodes in a network. The link state information is information about links from one node to neighbor nodes. Accordingly, each node receives the link state information of all other nodes, creates a topology of an entire network using the received information, and decides a path to a predetermined node based on the created topology. In the LSR, a flooding method is used to forward link state information. That is, when each node receives the link state information of other nodes, each node forwards the received link state information as it is. Accordingly, as the number of nodes increases, overhead for forwarding link station information abruptly increases.

Optimized link state routing (OLSR) is another routing method for a wireless network. According to the OLSR, each node transmits link state information of neighboring nodes to all other nodes in a network like the LSR. Unlike the LSR, however, predetermined nodes among nodes receiving the link state information forward the received link state information in order to prevent unnecessary retransmission, as caused by the flooding method of the LSR. In this way, the OLSR can reduce network overhead because the number of messages transmitted by each node is reduced. However, the OLSR could not completely overcome the overhead problem as a network expands in size and it is difficult to forward routing information in a bandwidth limited environment.

According to the LSR and the OLSR, each node creates routing information similar to the link state information, regardless of a bandwidth in a link layer, and transmits a request to the link layer. Accordingly, a large amount of routing information is accumulated in a queue in a bandwidth limited environment, creating an increase in delay for transmitting routing information. If the delay for transmitting routing information increases in each node, a delay for receiving the routing information abruptly increases as well.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for transmitting routing information in a bandwidth limited wireless network environment and a routing apparatus for supporting the same.

An exemplary embodiment of the present invention provides a method for transmitting routing information at a first node in a wireless network the present invention. In the method, a routing update message is generated, wherein the routing update message includes link information formed in a link unit. Then, the routing update message is transmitted to a second node in the wireless network. Here, the link denotes a transmission path between two node pair. The link information denotes quality of a corresponding link formed by a node pair.

Another exemplary embodiment of the present invention provides a routing apparatus for transmitting routing information in a wireless network, including a routing unit for generating a routing update message and transmitting the routing update message to neighbor nodes, wherein the routing update message includes link information formed in a link unit; and a link information managing unit for storing and managing a link information list, wherein the link information list is network topology information formed in a link unit.

Still another exemplary embodiment of the present invention provides the present invention provides a method for processing routing information at a first node in a wireless network. In the method, a routing update message including link information is received. The link information is formed in a link unit. Link information of a first link included in the routing update message is compared with a link information list stored in the first node. Then, the link information of the first link is added to the link information list when the link information of the first link is not included in the link information list.

Yet another exemplary embodiment of the present invention provides a routing apparatus for processing routing information at a first node in a wireless network. The routing apparatus includes a link information managing unit for storing a link information list wherein the link information list is network topology information formed in a link unit, and a routing unit for receiving a routing update message that includes link information formed in a link unit, comparing the link information included in the received routing update message with the link information list by a link unit, and processing the link information by a link unit.

### BRIEF DESCRIPTION OF THE DRAWINGS

FIG. 1 illustrates a wireless ad-hoc network according to an exemplary embodiment of the present invention.

FIG. 2 illustrates a TDMA frame structure.

FIG. 3 is a block diagram depicting a routing apparatus according to an exemplary embodiment of the present invention.

FIG. 4 is a flowchart that illustrates a method for updating a routing table.

FIG. 5 is a flowchart that illustrates a method for updating link information of a neighboring node at a routing apparatus 300 according to an exemplary embodiment of the present invention.

FIG. 6 is a flowchart that illustrates a method for generating a routing update message using an update interval timer according to an exemplary embodiment of the present invention.

FIG. 7 is a flowchart that illustrates a method for generating a routing update message according to an exemplary embodiment of the present invention.

FIG. 8 is a flowchart that illustrates a method for processing a routing update message received from other node at a routing apparatus 300 according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, in addition, unless explicitly described to the contrary, the word “comprise” and variations such as “comprises” or “comprising”, will be understood to imply the inclusion of stated elements but not the exclusion of any other elements.

In the specification, routing information denotes information that each router uses to setup a routing path. The routing information may include link state information. The routing information may be referred as link state information or link information.

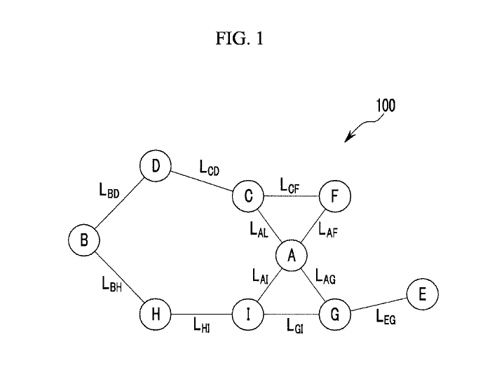

FIG. 1 is a diagram illustrating a wireless ad-hoc network according to an exemplary embodiment of the present invention.

Referring to FIG. 1, a wireless Ad hoc network 100 includes a plurality of nodes A, B, . . . , and I. Each node communicates with neighbor nodes. The neighbor nodes are nodes adjacent to a predetermined node.

For example, neighbor nodes of a node A may be a node C, a node F, a node I, and a node G. Here, a logical link is formed between each node and a neighbor node. For example, a link L_{AC} is formed between a node A and a node C, and a link L_{AF} may be formed between a node A and a node F. A solid line connected between two nodes denotes a link formed between two nodes in FIG. 1.

An exemplary embodiment of the present invention may be applied to any wireless network using a typical link layer protocol as well as a wireless ad hoc network. In the specification, a bandwidth limited environment includes the following three exemplary environments.

First, a bandwidth limited environment may be an environment where all nodes communicate using a same frame structure. For example, a frame includes an active period and an inactive period. The active period includes a contention access period and a contention free period. In general, a control message including routing information is transmitted through the contention access period. When a ratio of an active period is small because of a low power mode, a period allocated to transmit routing information may be very limited.

Second, a bandwidth limited environment may be an environment in which a control message and a data message are transmitted without distinction. Here, when a large number of data messages are transmitted, resources for transmitting a control message including routing information become lacking. Accordingly, routing information cannot be forwarded smoothly.

Last, a slot is allocated to a node in a link layer protocol that has a time division multiple access (TDMA) frame structure. Here, the number of slots allocated to one node is limited. As the number of nodes in a network increases, the number of slots allocated to each node becomes reduced; and the number of control messages, including routing information, increases. Accordingly, a period allocated to each node to forward routing information becomes very limited.

The above described bandwidth limited environments are only examples. The technical aspect of the present invention may be applied to various bandwidth limited environments. Hereinafter, a method for forwarding routing information using a TDMA frame structure according to an embodiment of the present invention will be described.

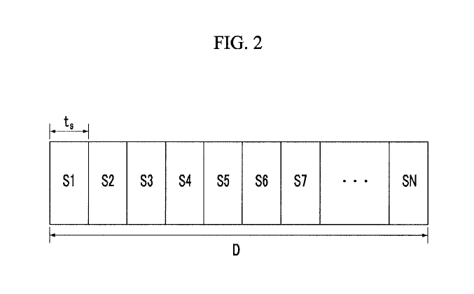

FIG. 2 is a diagram illustrating a TDMA frame structure.

Referring to FIG. 2, a TDMA frame structure includes a plurality of slots. Length of each slot denotes a slot time (ts). The fixed number of slots may be allocated to each TDMA frame having a predetermined length (D) in order to transmit the routing information of each node. Each node can broadcast a control message including routing information through allocated slots.

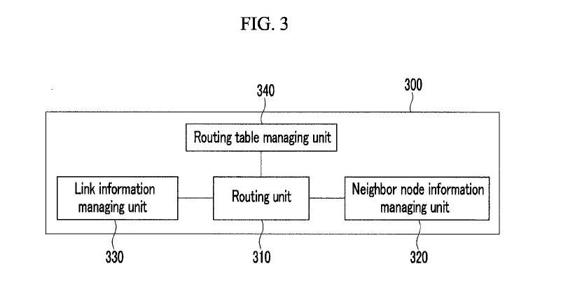

FIG. 3 is a block diagram illustrating a routing apparatus according to an exemplary embodiment of the present invention. The routing apparatus 300 may be included in a connection managing apparatus. The connection managing apparatus provides the Quality of Service (QoS) of each node. The connection managing apparatus receives a data transmission request from an upper layer link, establishes and manages a link, measures the QoS of a link, allocates resources of a link layer, stores routing information, and exchanges routing information.

Referring to FIG. 3, the routing apparatus 300 includes a routing unit 310, a neighbor node information managing unit 320, a link information managing unit 330, and a routing table managing unit 340.

The routing unit 310 searches neighbor nodes that can exchange routing information and exchanges the routing information with the searched neighbor nodes. In order to search neighbor nodes, the routing unit 310 may regularly transmit a message based on a neighbor node search protocol or transmit a beacon message from a media access control (MAC) layer. The routing unit 310 transmits a control message to a network. The control message includes its own routing information or the routing information of other nodes. Each node acquires and maintains network topology information and sets up an optimal path.

The neighbor node information managing unit 320 stores and manages neighbor node information obtained through neighbor node searching. The neighbor node information may be stored in a form of a list as shown in Table 1.

TABLE 1

| Item | Type | Description |
|---|---|---|
| Neighbor node ID | Address | Node ID of neighbor node |
| link metric | Integer | Metric denotes quality |
| | | of link (RSSI, ETX, etc) |
| Update time | Timestamp | Last updated time |

Referring to Table 1, the neighbor node information includes neighbor node ID information, link metric information, and update time information. The link metric information denotes link quality.

The link information managing unit 330 stores and manages network topology information in a unit of a link. The link information managed by the link information managing unit 330 may be created based on neighbor node information maintained by itself, or the link information may be obtained using received routing update information. The topology information of the link unit may be stored in a form of a list as shown in Table 2. Hereinafter, the link unit topology information may be referred as a link information list.

TABLE 2

| Item | Type | Description |
|---|---|---|
| Node 1 | Address | First node among node part of link |
| Node 2 | Address | Second node in node pare of link |
| Link metric | Integer | Metric denoting quality |
| | | of link (RSSI, ETX etc) |
| Sequence number | Integer | Sequence number of link information |
| Add time | Timestamp | Time of adding new link information |
| Update time | Timestamp | Last updated time |
| Transmission time | Timestamp | Last transmitted time |
| Link loss | Flag | 1 for lost link |

Referring to Table 2, the link unit topology information includes addresses of nodes (node 1 and node 2) forming a link, link metric information, sequence number information, add time information for a time of adding link information, update time information, transmission time information, and link loss information for lost link.

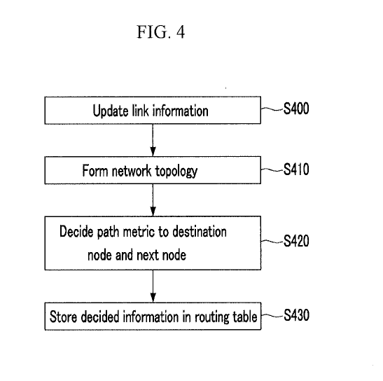

The routing table managing unit 340 updates a routing table whenever the link information managing unit 330 updates the link information. A method for updating such a routing table will be described with reference to FIG. 4. Referring to FIG. 4, when link information is updated at step S400, the link information managing unit 330 creates a network topology based on the updated link information at step S410. The routing table managing unit 340 decides a path metric to a destination node and a next node toward the destination node based on the network topology at step S420, and stores the decided path metric and the decided next node at the routing table at step S430.

The routing table may be stored in a form of a list as shown in Table 3.

TABLE 3

| Item | Type | Description |
|---|---|---|
| Destination node | Address | Address of destination node |
| Next node | Address | Next node toward destination node |
| Path metric | Integer | Metric denotes quality |
| | | of path (Hop number, ETX etc) |
| Update time | Timestamp | Last update time |

Referring to Table 3, the routing table includes addresses of a node and a next node, path metric information and update time information. Here, the next node denotes a next node toward a destination node.

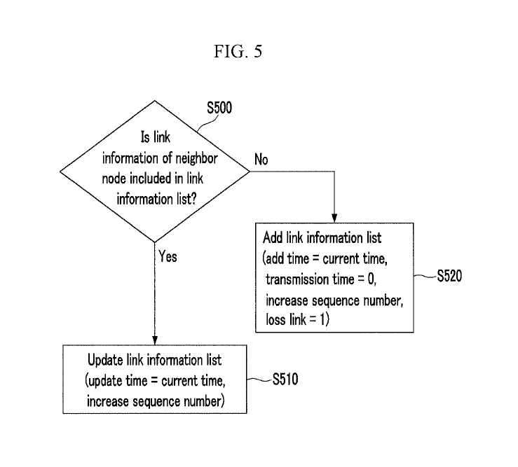

FIG. 5 is a flowchart that illustrates a method of updating link information of a neighbor node at a routing apparatus 300 according to an exemplary embodiment of the present invention. The routing apparatus 300 may regularly update link information of neighbor nodes. A cycle for updating the link information of neighbor nodes may be a predetermined value. For example, the predetermined value may be used to decide a cycle for propagating neighbor node information of each node to a network.

Referring to FIG. 5, the routing apparatus 300 searches neighbor node information from a link information list stored in a link information managing unit 330 at step S500. If the link information list includes link information of own neighbor node, then the link information list is updated using neighbor node information newly obtained from the neighbor node information managing unit 320 at step S510. Here, an update time of updating the link information list may be set up with a current time, and a sequence number may be increased.

On the contrary, if the link information list does not include link information of own neighbor node, the neighbor node information obtained from the neighbor node information managing unit 320 is added to the link information list at step S520. In the step S520, a time of adding the neighbor node information into the link information list is set up as a current time, and a transmission time is set up as 0, a sequence number is increased, and a loss link is marked.

The routing apparatus 300 repeats the steps S500 to S520 until all neighbor node information is updated or added.

Hereinafter, a method for generating a routing update message at the routing apparatus 300 will be described. The routing unit 310 of the routing apparatus 300 may generate the routing update message.

For example, the routing unit 310 may generate a routing update message when a request is received from a MAC layer. That is, the MAC layer requests the routing unit 310 to generate a routing update message at an opportunity of transmitting routing information. The routing unit 310 generates the routing update message and requests the MAC layer to transmit.

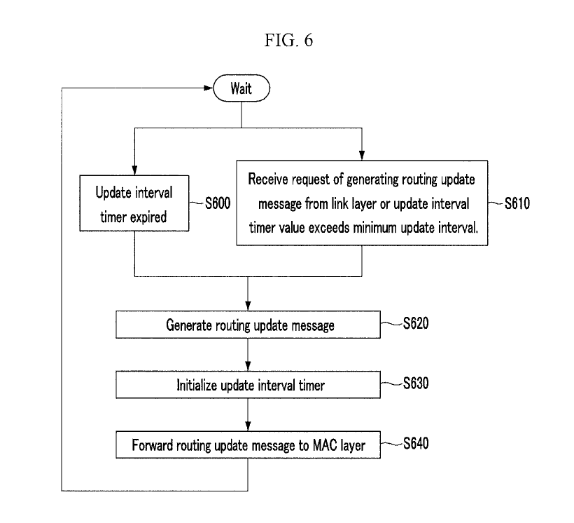

For another example, the routing unit 310 may generate a routing update message using an update interval timer. FIG. 6 is a flowchart that illustrates a method for generating a routing update message using an update interval timer according to an exemplary embodiment of the present invention.

Referring to FIG. 6, when an update interval timer is expired without the routing unit 310 receiving a routing update message from the MAC layer at step S600 or when a value of the update interval timer becomes greater than a minimum update interval without receiving a request for generating a update message from the link layer or without receiving a request for generating a routing update message from the MAC layer at step S610, the routing unit 310 generates a routing update message at step S620. Then, the routing unit 310 initializes the update interval timer at step S630, and forwards the generated routing update message to the MAC layer at step S640. The MAC layer stores the routing update message in a queue and transmits the routing update message at a transmission opportunity.

Table 4 exemplary shows the routing update message.

TABLE 4

| Item | | type | Description |
|---|---|---|---|
| Source node | | Address | Address of a node transmitting a routing |
| | | | update message |
| The number of node | | Integer | The number of nodes forwarding link |
| forwarding link | | | information |
| information | | | 0: no node forwarding the link information |
| | | | 0xff: all nodes forwarding link information |
| | | | (no item provided for showing address of |
| | | | node forwarding information) |
| Per entry | Address of | Address | Address of a node delivering |
| | node | | |
| | forwarding | | |
| | information | | |
| The number of link | | Integer | The number of link information transferred |
| information | | | from a routing update message |
| Per entry | link | Link Information | link information |
| | information | | |

Referring to Table 4, the routing update message includes an address of a source node that transmits a routing update message, the number of node (forwarder) forwarding the routing update message to a destination node, an address of the forwarder, the number of link information including a routing update message, and link information.

The number of link information is the number of maximum link information that one routing update message can store. The number of link information is predetermined variable information and may be decided based on the maximum transmission capacity of a link layer.

Meanwhile, only one node assigned as a forwarder among nodes receiving a routing update message retransmits link information included in a routing update message. Accordingly, routing information is efficiently forwarded to a network.

The link information may be generated based on a link information list stored in the link information manager 330. Table 5 exemplary shows link information stored in a routing update message.

TABLE 5

| Item | Type | Description |
|---|---|---|
| Node 1 | Address | Firs node in a pair of nodes forming a link |
| Node 2 | Address | Second node in a pair of |
| | | nodes forming a link |
| Link Metric | Integer | Metric denoting quality |
| | | of a link (RSSI, ETX etc) |
| Sequence Number | Integer | Sequence Number of link information |
| loss link | Flag | Lost link is marked as 1 |

Referring to Table 5, the link information included in the routing update message includes addresses of first and second nodes 1 and 2 that form a link, link metric information, sequence number information, and link loss information.

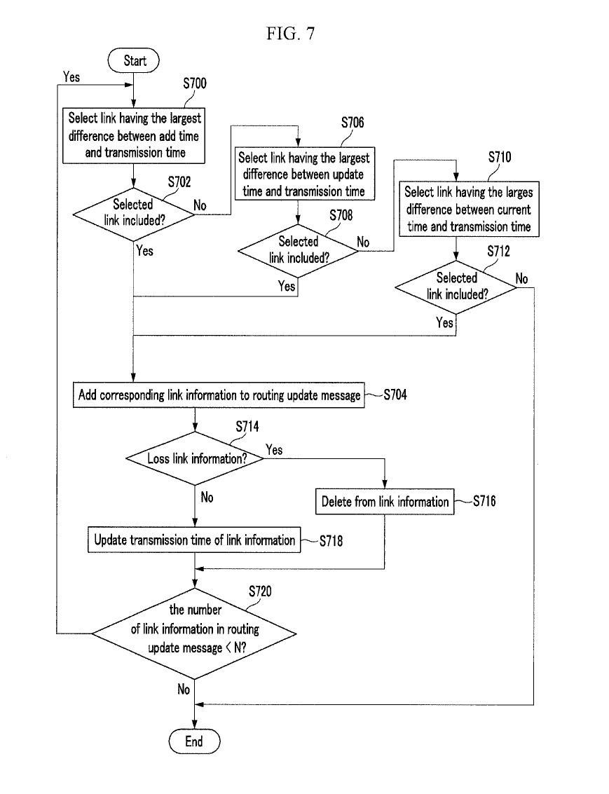

FIG. 7 is a flowchart that illustrates a method for generating a routing update message according to an exemplary embodiment of the present invention.

Referring to FIG. 7, a routing unit 310 searches a link having the largest difference between an add time and a transmission time (add time−transmission time) from a link information list in a link information managing unit 330 at step S700. When the link information list includes the link having the largest difference (add time−transmission time) at step S702, link information of a corresponding link is added into the routing update message at step S704.

When the link information list does not includes a link having the largest difference of the add time and the transmission time (add time−transmission time), the routing unit 310 searches a link having the largest difference between an update time and a transmission time (update time−transmission time) from the link information list at step S706. When the link information list includes a link having the largest difference between the update time and the transmission time (update time−transmission time) at step S708, link information of a corresponding link is added to the routing update message at step S704.

If the link information list does not include the largest difference (update time−transmission time), the routing unit 310 searches a link having the largest difference between a current time and a transmission time (current time−transmission time) from the link information list at step S710. If the link information list includes a link having the largest difference (current time−transmission time) at step S712, link information of a corresponding link is added to the routing update message at step S704.

Then, the routing unit 310 checks a loss link item from link information at step S714. If corresponding link information is information of a lost link, the corresponding link information is deleted from the routing update message and the link information list at step S716. If corresponding link information is not information of a lost link, a transmission time of the link information list is updated at step S718.

When the number of link information in the routing update message is smaller than the maximum link information number (N), the above described steps are repeated at step S720.

The generated routing update message may include only the predetermined number of link information. Here, the link information may be included in the routing update message based on a priority. For example, a priority is assigned in an order of newly added link information, newly updated link information, and link information having the last transmission time. That is, link information changing a network topology is propagated with the first priority and the latest link information is propagated thereafter.

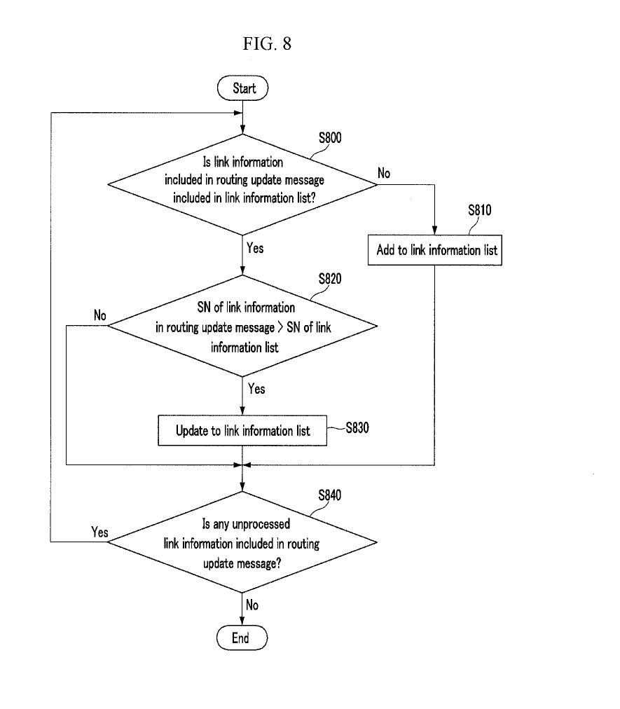

FIG. 8 is a flowchart that illustrates a method for processing a routing update message received from other nodes at a routing apparatus 300 according to an exemplary embodiment of the present invention.

Referring to FIG. 8, the routing apparatus 300 compares a received routing update message with a link information list stored in the link information managing unit 330 at step S800. When the link information list and the received routing update message do not include the same link information, the routing apparatus 300 adds the link information included in the received routing update message to the link information list at step S810. Here, an add time and an update time are set up as a current time, and a transmission time is initialized to 0.

If the link information list and the routing update message include the same link information, the routing apparatus 300 compares a sequence number of the link information list with that of link information stored in the routing update message at step S820. If the link information included in the routing update message has the latest sequence number than that of the link information list, the routing apparatus 300 updates the link information list at step S830. Here, an update time is set up as a current time.

The routing apparatus 300 repeats the above described steps for all link information included in the routing update message at step S840.

Meanwhile, the routing apparatus 300 checks a forwarder item in the routing update message. When an own address is not included in the forwarder item, the routing apparatus 300 does not instantly forward a corresponding routing update message to other node. For example, a transmission time is set up as a current time when the link information list is added or updated.

As described above, the routing apparatus 300 decomposes link information included in a routing update message received from other node in a link unit and processes the decomposed link information in a link unit.

According to an exemplary embodiment of the present invention, routing information can be effectively forwarded even in an environment having a limited bandwidth for routing. Therefore, changed topology information and updated routing information can be rapidly propagated through a network, and each node can search an optimal path based on the changed and update information.

Further, a limited bandwidth can be efficiently used by limiting the number of nodes forwarding the routing information.

The apparatus and method according to an exemplary embodiment of the present invention described above can be realized as a program performing functions corresponding to configuration elements of the apparatus and method or as a computer readable recording medium storing the program. Since the realization can be easily implemented by those skilled in the art to which the exemplary embodiment of the present invention pertains, further description will not be provided herein.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for transmitting routing information at a first node in a wireless network, comprising:
generating a routing update message, wherein the routing update message includes link information formed in a link unit; and
transmitting the routing update message to a second node in the wireless network.

2. The method of claim 1, wherein the routing update message further includes information about a maximum link information number included in the routing update message,
wherein the generating a routing update message includes adding the link information to the routing update message based on a priority of the link information.

3. The method of claim 2, wherein the priority of the link information is decided based on change of a topology of the wireless network.

4. The method of claim 2, wherein the priority of the link information is decided based on at least one of an add time of newly adding link information included in a link information list managed by the first node, an update time of updating link information, and a current time, and a transmission time of lastly transmitting link information.

5. The method of claim 4, wherein a first link information having a largest difference between the add time and the transmission time has a first highest priority, a second link information having a largest difference between the update time and the transmission time has a second highest priority, and a third link information having a largest difference between the current time and the transmission time has a third highest priority.

6. The method of claim 1, wherein the routing update message further includes information on a forward node, wherein the forward node forwards the routing update message.

7. The method of claim 1, wherein: the link information includes a sequence number of each link.

8. A routing apparatus for transmitting routing information in a wireless network, comprising:
a routing unit for generating a routing update message and transmitting the routing update message to neighbor nodes, wherein the routing update message includes link information formed in a link unit; and
a link information managing unit for storing and managing a link information list, wherein the link information list is network topology information formed in a link unit.

9. The routing apparatus of claim 8, wherein the routing update message further includes information about a maximum link information number included in the routing update message,
the routing unit adds link information to the routing update message based on a priority, wherein the link information is included in the link information list.

10. The routing apparatus of claim 9, wherein the priority is decided based on change of a topology of the wireless network.

11. The routing apparatus of claim 8, wherein the link information list includes addresses of two nodes in a pair, link quality, a sequence number of link information included in the link information list, an add time of adding link information included in the link information list, an update time of updating link information included in the link information list, a transmission time of lastly transmitting link information included in the link information list, and an indication for a lost link.

12. The routing apparatus of claim 8, further comprising:
a neighbor node information managing unit for storing and managing neighbor node information searched by the routing unit.

13. The routing apparatus of claim 12, wherein the neighbor node information managing unit regularly updates neighbor node information.

14. A method for processing routing information at a first node in a wireless network, comprising;
receiving a routing update message including link information, wherein the link information is formed in a link unit;
comparing link information of a first link included in the routing update message with a link information list stored in the first node; and
adding the link information of the first link to the link information list when the link information of the first link is not included in the link information list.

15. The method of claim 14, further comprising:
comparing a sequence of the link information list with a sequence number in the link information of the first link when the link information of the first link is included in the link information list;
updating the link information list with the link information of the first link when the sequence number of the link information of the first link is later than the sequence number of the link information list.

16. The method of claim 14, wherein the routing update message further includes forward node information, wherein the forward node information is information on a forward node, and the forward node is a node forwarding the routing update message, and
wherein the method further comprising: setting the first node not to forward link information included in the routing update message when the forward node information does not include an address of the first node.

17. A routing apparatus for processing routing information at a first node in a wireless network, comprising:
a link information managing unit for storing a link information list wherein the link information list is network topology information formed in a link unit; and
a routing unit for receiving a routing update message that includes link information formed in a link unit, comparing the link information included in the received routing update message with the link information list by a link unit, and processing the link information by a link unit.

18. The routing apparatus of claim 17, wherein the routing unit compares link information of a first link included in the routing update message with the link information list, and
the link information of the first link is added to the link information list when the link information of the first link is not included in the link information list.

19. The routing apparatus of claim 17, wherein the routing unit compares link information of a first link included in the routing update message with the link information list,
compares a sequence number of the link information of the first link with a sequence number of the link information list when the link information list include the link information of the first link, and
updates the link information list to the link information of the first link when the sequence number of the link information of the first link is later than the sequence number of the link information list.

20. The routing apparatus of claim 17, wherein the routing update message further includes forward node information, wherein the forward node information is information on a forward node, and the forward node is a node forwarding the routing update message,
the routing unit forwards the routing update message to a second node when the forward node information includes an address of the first node, and
the routing unit is set to not instantly forward the routing update message to the second node when the forward node information does not include the address of the first node,
